(19) United States
(12) Patent Application Publication
(10) Pub. No.: US 2024/0291166 A1
(43) Pub. Date: Aug. 29, 2024

(54) ANTENNA MODULE AND COMMUNICATION APPARATUS INCLUDING THE SAME

(71) Applicant: Murata Manufacturing Co., Ltd., Nagaokakyo-shi (JP)

(72) Inventor: Yosuke SATO, Nagaokakyo-shi (JP)

(73) Assignee: Murata Manufacturing Co., Ltd., Nagaokakyo-shi (JP)

(21) Appl. No.: 18/656,624

(22) Filed: May 7, 2024

Related U.S. Application Data
(63) Continuation of application No. PCT/JP2022/040733, filed on Oct. 31, 2022.

(30) Foreign Application Priority Data
Nov. 17, 2021 (JP) 2021-186950

(51) Int. Cl. H01Q 19/00; H01Q 9/04; H01Q 21/06

(52) U.S. Cl. CPC H01Q 19/005; H01Q 9/0407; H01Q 21/065

(57) ABSTRACT

An antenna module includes a dielectric substrate, radiating elements disposed in or on the dielectric substrate, and dielectrics. In plan view in a normal line direction of the dielectric substrate, the radiating element is disposed adjacent to the radiating element. The dielectric is disposed to cover the radiating element, and the dielectric is disposed to cover the radiating element. The dielectric is disposed to be spaced away from the dielectric. A frequency band for a radio wave emitted from the radiating element is higher than a frequency band for a radio wave emitted from the radiating element. The dielectrics each have a higher dielectric constant than the dielectric substrate.

### CROSS-REFERENCE TO RELATED APPLICATIONS

The present application is a continuation of PCT application no. PCT/JP2022/040733, filed Oct. 31, 2022, which claims priority to Japanese application no. JP 2021-186950, filed Nov. 17, 2021. The entire contents of both prior applications are hereby incorporated by reference.

### TECHNICAL FIELD

The present disclosure relates to an antenna module and a communication apparatus including the same and more particularly relates to technology for improving antenna characteristics of an antenna module capable of emitting a radio wave in a plurality of frequency bands.

### BACKGROUND ART

To date, a configuration of an antenna having a radiating element of a plate shape is known, the configuration having a dielectric disposed on the radiating element. For example, Japanese Examined Patent Application Publication No. 6-80975 (Patent Document 1) discloses a dielectric-loaded antenna. In the dielectric-loaded antenna, patch antennas are arranged in an array form, a reflective plate is provided on a surface of a dielectric plate on which each patch antenna is disposed, the surface being on an opposite side of the dielectric plate from the patch antenna, and columnar dielectrics are loaded in such a manner as to be opposed to the reflective plate with the respective patch antennas interposed therebetween. With the configuration of the dielectric-loaded antenna in Japanese Examined Patent Application Publication No. 6-80975 (Patent Document 1), aperture efficiency deterioration is reduced, and an antenna gain (gain) is improved.

Japanese Unexamined Patent Application Publication No. 9-199938 (Patent Document 2) discloses a configuration of an antenna device for receiving a circularly polarized wave. In the configuration, among microstrip radiating elements arranged in an array form, dielectrics are each disposed on part of the elements in a specific direction. With the configuration disclosed in Japanese Unexamined Patent Application Publication No. 9-199938 (Patent Document 2), the reception gain of a radio wave in a direction in which the dielectrics are arranged.

### CITATION LIST

### Patent Document

Patent Document 1: Japanese Examined Patent Application Publication No. 6-80975
Patent Document 2: Japanese Unexamined Patent Application Publication No. 9-199938

### Summary Technical Problems

In recent years, development of communication apparatuses supporting a plurality of communication standards has been promoted. Such a communication apparatus is required to transmit and receive radio waves in different frequency bands specified on a per communication standard basis, and thus antennas for respective frequency bands are disposed on the same substrate in some cases.

In such an antenna module supporting a plurality of frequency bands, further improvement of antenna characteristics such as band widening or higher gain is required for radio waves in the respective frequency bands. However, a parameter (such as a dielectric constant) appropriate for an antenna characteristic varies with the target frequency band, and thus the configuration in which antennas for different frequency bands are disposed on the same substrate does not necessarily enable the respective parameters of all of the antennas to be optimized on occasions.

The present disclosure has been made to address the issue described above, as well as other issues, and aims to improve antenna characteristics of radiating elements in an antenna module having the radiating elements for the respective different frequency bands disposed on a shared dielectric substrate.

### Solutions to Problems

An antenna module according to a first aspect of the present disclosure includes a dielectric substrate, a first radiating element disposed in or on the dielectric substrate, a second radiating element, a first dielectric, and a second dielectric. The second radiating element is disposed adjacent to the first radiating element in plan view in a normal line direction of the dielectric substrate. The first dielectric is disposed to cover the first radiating element, and the second dielectric is disposed to cover the second radiating element. The second dielectric is spaced away from the first dielectric. A frequency band of a radio wave emitted from the second radiating element is higher than a frequency band of a radio wave emitted from the first radiating element. The first dielectric and the second dielectric have higher dielectric constants than the dielectric substrate.

An antenna module according to a second aspect of the present disclosure includes a dielectric substrate, a plurality of first radiating elements, a plurality of second radiating elements, first dielectrics, and second dielectrics. The plurality of first radiating elements and the plurality of second radiating elements are arranged in a first direction in or on the dielectric substrate. The plurality of second radiating elements are arranged adjacent to the plurality of first radiating elements in plan view in a normal line direction of the dielectric substrate. The plurality of first radiating elements are each individually covered with the first dielectrics, and the plurality of second radiating elements are each individually covered with a corresponding one of the second dielectrics. The second dielectrics are disposed to be spaced away from the first dielectrics. A frequency band of a radio wave emitted from each of the plurality of second radiating elements is higher than a frequency band of a radio wave emitted from each of the plurality of first radiating elements. The first dielectrics and the second dielectrics have higher dielectric constants than the dielectric substrate.

### Advantageous Effects of Disclosure

In the antenna module according to the present disclosure, the radiating elements (the first radiating element and the second radiating element) for two types of frequency bands that are disposed in and on the shared dielectric substrate have the configuration in which the radiating elements are individually covered with the dielectrics (the first dielectric and the second dielectric) each having a dielectric constant higher than that of the dielectric substrate. The first dielectric and the second dielectric are disposed to be spaced away from each other. The configuration as described above enables, to be improved, antenna characteristics of the radiating elements of the antenna module having the radiating elements for the respective different frequency bands disposed on the shared dielectric substrate.

### BRIEF DESCRIPTION OF DRAWINGS

FIG. 1 is a block diagram of a communication apparatus to which an antenna module according to Embodiment 1 is applied.

FIG. 2 is a plan view and a side perspective view of the antenna module in FIG. 1.

FIG. 3 is a view for explaining antenna gains in the antenna module in FIG. 1 and antenna modules in comparative examples.

FIG. 4 is a side perspective view of an antenna module according to Embodiment 2.

FIG. 5 is a plan view of an antenna module according to Embodiment 3.

FIG. 6 is a plan view of an antenna module in a modification.

FIG. 7 is a plan view of an antenna module according to Embodiment 4.

### DESCRIPTION OF EMBODIMENTS

Hereinafter, embodiments of the present disclosure will be described in detail with reference to the drawings. The same or corresponding components are denoted by the same reference numerals, and the description thereof is not repeated.

### Embodiment 1

### (Basic Configuration of Communication Apparatus)

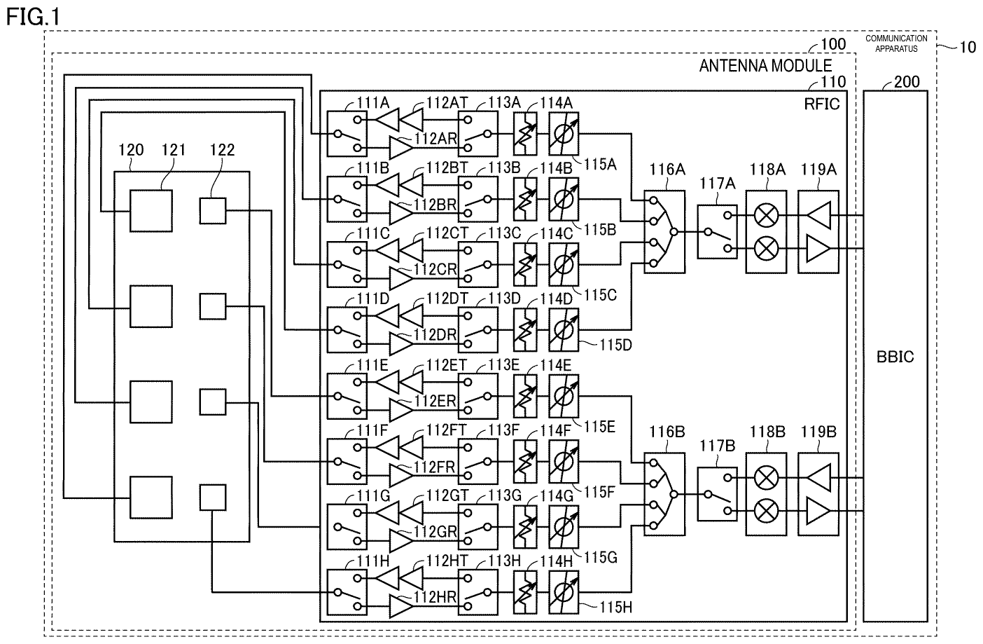

FIG. 1 is an example of a block diagram of a communication apparatus 10 to which an antenna module 100 according to this Embodiment 1 is applied. For example, the communication apparatus 10 is a mobile terminal such as a mobile phone, a smartphone, or a tablet, or a personal computer having a communication function. An example of the frequency band of a radio wave used for the antenna module 100 according to this embodiment is a radio wave in a millimeter wave band having a center frequency of, for example, 28 GHz, 39 GHz, or 60 GHz; however, a radio wave in a frequency band other than the above is also applicable.

With reference to FIG. 1, the communication apparatus 10 includes the antenna module 100 and a BBIC 200 forming a baseband signal processing circuit. The antenna module 100 includes a RFIC 110 that is an example of a feed circuit and an antenna device 120. The communication apparatus 10 upconverts a signal transmitted from the BBIC 200 to the antenna module 100 into a radio frequency signal by using the RFIC 110 and emits the signal from the antenna device 120. The communication apparatus 10 also transmits the radio frequency signal received by the antenna device 120 to the RFIC 110 and downconverts the signal by using the BBIC 200.

The antenna module 100 is an antenna module of what is called a dual band type that is capable of emitting radio waves in different two frequency bands. The antenna device 120 includes a plurality of radiating elements 121 that emit radio waves with lower frequencies and a plurality of radiating elements 122 that emit radio waves with higher frequencies. In the example in Embodiment 1, the frequency band of the radiating elements 121 is a 28 GHz band, and the frequency band of the radiating elements 122 is a 39 GHz band.

For easy explanation, FIG. 1 illustrates the configuration of the RFIC 110 having component groups each corresponding to four radiating elements of the plurality of radiating elements (feed elements) 121 and 122 constituting the antenna device 120. FIG. 1 illustrates an example of a configuration in which the plurality of radiating elements 121 and 122 in the antenna device 120 are arranged in line in a one-dimensional array form; however, the plurality of radiating elements 121 and 122 may be formed in a two-dimensional array. The antenna device 120 may also have a configuration in which one radiating element 121 and one radiating element 122 are provided. In this embodiment, the radiating elements 121 and 122 are both a plate-shaped patch antenna.

The RFIC 110 includes switches 111A to 111H, 113A to 113H, 117A, and 117B, power amplifiers 112AT to 112HT, low-noise amplifiers 112AR to 112HR, attenuators 114A to 114H, phase shifters 115A to 115H, a signal multiplexer/demultiplexer 116A, a signal multiplexer/demultiplexer 116B, mixers 118A and 118B, and amplifier circuits 119A and 119B. Of these components, the switches 111A to 111D, 113A to 113D, and 117A, the power amplifiers 112AT to 112DT, the low-noise amplifiers 112AR to 112DR, the attenuators 114A to 114D, the phase shifters 115A to 115D, the signal multiplexer/demultiplexer 116A, the mixer 118A, and the amplifier circuit 119A form a circuit for each radiating element 121 for the lower frequencies. The switches 111E to 111H, 113E to 113H, and 117B, the power amplifiers 112ET to 112HT, the low-noise amplifiers 112ER to 112HR, the attenuators 114E to 114H, the phase shifters 115E to 115H, the signal multiplexer/demultiplexer 116B, the mixer 118B, and the amplifier circuit 119B form a circuit for each radiating element 122 for the higher frequencies.

In a case where a radio frequency signal is transmitted, the switches 111A to 111H and 113A to 113H are switched over to the power amplifiers 112AT to 112HT, and the switches 117A and 117B are connected to amplifiers on the transmission side in the amplifier circuits 119A and 119B. In a case where the radio frequency signal is received, the switches 111A to 111H and 113A to 113H are switched over to the low-noise amplifiers 112AR to 112HR, and the switches 117A and 117B are connected to amplifiers on the reception side in the amplifier circuits 119A and 119B.

Signals transmitted from the BBIC 200 are amplified by the amplifier circuits 119A and 119B and upconverted by the mixers 118A and 118B. The transmission signals that are upconverted radio frequency signals are demultiplexed into four signals by the signal multiplexer/demultiplexer 116A and the signal multiplexer/demultiplexer 116B and supplied to the radiating elements 121 and 122 via respective signal paths. At this time, the phase shift degrees of the respective phase shifters 115A to 115H disposed on the signal paths are controlled individually, and the directivity of the antenna device 120 can thereby be controlled.

Reception signals that are radio frequency signals received by the respective radiating elements 121 and 122 are transmitted to the RFIC 110 and multiplexed by the signal multiplexer/demultiplexer 116A and the signal multiplexer/demultiplexer 116B via four respective different signal paths. The multiplexed reception signals are downconverted by the mixers 118A and 118B, amplified by the amplifier circuits 119A and 119B, and transmitted to the BBIC 200.

### (Antenna Module Structure)

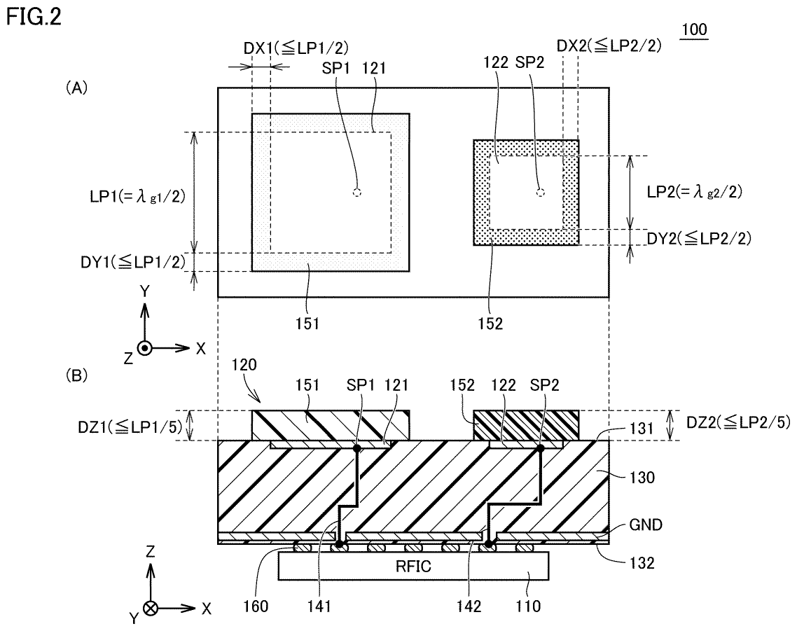

Details of the configuration of the antenna module 100 in Embodiment 1 will then be described by using FIG. 2. FIG. 2 is a view illustrating the antenna module 100 according to Embodiment 1. FIG. 2 illustrates a plan view of the antenna module 100 (FIG. 2(A)) in an upper part and a side perspective view (FIG. 2(B)) in a lower part. For easy explanation, a case where one radiating element 121 and one radiating element 122 are illustrated in FIG. 2 is described as an example.

The antenna module 100 includes a dielectric substrate 130, feed wiring lines 141 and 142, dielectrics 151 and 152, and a ground electrode GND in addition to the radiating elements 121 and 122 and the RFIC 110. In the following description, a direction of a normal line of the dielectric substrate 130 (an emission direction of a radio wave) is a Z-axis direction. On a surface perpendicular to the Z-axis direction, a direction in which the radiating elements 121 and 122 are disposed is defined as an X axis, and a direction orthogonal to the X axis is defined as a Y axis. A positive direction and a negative direction along the Z axis in the drawings are respectively referred to as an upper side and a lower side on occasions.

The dielectric substrate 130 is, for example, a low-temperature co-fired ceramic (LTCC) multi-layer substrate, a multi-layer resin substrate formed by laminating a plurality of resin layers formed from resin such as epoxy or polyimide, a multi-layer resin substrate formed by laminating a plurality of resin layers formed from liquid crystal polymer (LCP) having a lower dielectric constant, a multi-layer resin substrate formed by laminating a plurality of resin layers formed from fluorine-based resin, a multi-layer resin substrate formed by laminating a plurality of resin layers formed from a PET (Polyethylene Terephthalate) material, or a ceramic multi-layer substrate other than the LTCC. The dielectric substrate 130 does not necessarily have to have the multi-layer structure and may be a single-layer substrate.

In plan view in the normal line direction (Z-axis direction), the dielectric substrate 130 has a rectangular shape. The radiating elements 121 and 122 are disposed adjacent to each other in an X-axis direction in a layer (a layer on the upper side) close to an upper surface 131 (a surface in the positive direction along the Z axis) of the dielectric substrate 130. The radiating elements 121 and 122 may be disposed in such a manner as to be exposed from the surface of the dielectric substrate 130 and may be disposed inside the dielectric substrate 130. The ground electrode GND is disposed over the entire dielectric substrate 130 and near the lower surface 132 of the dielectric substrate 130.

Each of the radiating elements 121 and 122 is a plate electrode of substantially a square shape. The size of the radiating element 122 is smaller than the size of the radiating element 121, and the resonant frequency of the radiating element 122 is higher than the resonant frequency of the radiating element 121. The frequency band of a radio wave emitted from the radiating element 122 is higher than the frequency band of a radio wave emitted from the radiating element 121. A radio frequency signal is supplied from the RFIC 110 to each of the radiating elements 121 and 122 via a corresponding one of the feed wiring lines 141 and 142.

The feed wiring line 141 penetrates through the ground electrode GND from the RFIC 110 and is connected to a feed point SP1 of the radiating element 121. The feed wiring line 142 penetrates through the ground electrode GND from the RFIC 110 and is connected to a feed point SP2 of the radiating element 122. The feed point SP1 is shifted from the center of the radiating element 121 in the positive direction along the X axis, and the feed point SP2 is shifted from the center of the radiating element 122 in the positive direction along the X axis. A radio wave is thereby emitted from each of the radiating elements 121 and 122 in the X-axis direction serving as a polarization direction.

In the configuration in FIG. 2, each of the feed wiring lines extends linearly in the Z-axis direction in the dielectric substrate to be connected to a corresponding one of the radiating elements; however, each feed wiring line may be disposed to form a meandering path from a portion below the radiating element to the radiating element. The radiating element and the feed wiring line do not have be connected directly, and a configuration in which capacitive coupling using a plate electrode provided to an end portion of the feed wiring line causes a radio frequency signal to be supplied to the radiating element may be used. Further, a stub may be provided to the feed wiring line for impedance matching and/or an unwanted wave filtering.

The RFIC 110 is mounted on the lower surface 132 of the dielectric substrate 130 with solder bumps 160 interposed therebetween. The RFIC 110 may be connected to the dielectric substrate 130 by using multipole connectors, instead of the soldering connection.

The dielectric 151 is disposed in an area covering the radiating element 121 on the upper surface 131 of the dielectric substrate 130, and the dielectric 152 is disposed in an area covering the radiating element 122. Each of the dielectric constants of the respective dielectrics 151 and 152 is higher than the dielectric constant of the dielectric substrate 130, and further, a dielectric constant ε1 of the dielectric 151 is higher than a dielectric constant ε2 of the dielectric 152 (ε1>ε2). The dielectrics 151 and 152 are disposed to be spaced away from each other. If the dielectrics 151 and 152 have the same dielectric constant (ε1=ε2), or even if the dielectric constant of each dielectric 151 is lower than the dielectric constant of each dielectric 152 (ε1<ε2), the substantial dielectric constant of the dielectric 151 may be made higher than that of the dielectric 152 by causing the dielectrics 151 and 152 to have different sizes.

In plan view in the normal line direction of the dielectric substrate 130, each dielectric 151 has a shape of substantially a square and slightly larger in size than the corresponding radiating element 121. A distance DX1 between an end portion of the radiating element 121 and an end portion of the dielectric 151 in the X-axis direction is set to be shorter than or equal to ½ of a length LP1 of one of the sides of the radiating element 121 (DX1≤LP1/2). A distance DY1 between an end portion of the radiating element 121 and an end portion of the dielectric 151 in a Y-axis direction is also set to be shorter than or equal to ½ of the length LP1 of the side of the radiating element 121 (DY1≤LP1/2). In a case where the wavelength of the radio wave emitted from the radiating element 121 in the dielectric substrate 130 is λ_{g1}, the length LP1 of the side of the radiating element 121 is set to be λ_{g1}/2. A thickness (that is, the dimension in the Z-axis direction) DZ1 of the dielectric 151 is set to be shorter than or equal to ⅕ of the length LP1 of the side of the radiating element 121 (DZ1≤LP1/5).

Likewise, in plan view in the normal line direction of the dielectric substrate 130, the dielectric 152 has a shape of substantially a square slightly larger in size than the corresponding radiating element 122. A distance DX2 between an end portion of the radiating element 122 and an end portion of the dielectric 152 in the X-axis direction is set to be shorter than or equal to ½ of a length LP2 of one of the sides of the radiating element 122 (DX2≤LP2/2) A distance DY2 between an end portion of the radiating element 122 and an end portion of the dielectric 152 in the Y-axis direction is also set to be shorter than or equal to ½ of the length LP2 of the side of the radiating element 122 (DY2≤LP2/2) In a case where the wavelength of the radio wave emitted from the radiating element 122 in the dielectric substrate 130 is λ_{g2}, the length LP2 of the side of the radiating element 122 is set to be λ_{g2}/2. A thickness (that is, the dimension in the Z-axis direction) DZ2 of the dielectric 152 is set to be shorter than or equal to ⅕ of the length LP1 of the side of the radiating element 122 (DZ2≤LP2/5).

Typically, in the plate-shaped patch antenna, as a Q value determined from a ratio between radiant power and accumulated power due to a radiating element and a ground electrode becomes lower, a frequency bandwidth tends to be increased. For example, if a distance between the radiating element and the ground electrode is made longer, or if a dielectric constant between the radiating element and the ground electrode is lowered, the Q value is lowered, and thus the frequency bandwidth is increased.

If the top part of the radiating element is covered with a dielectric having a higher dielectric constant than that of a dielectric substrate, a surface acoustic wave generated from the radiating element tends to be stronger, and a line of electric force generated from an end portion of the radiating element in a direction along an electrode surface extends farther than in a case without a dielectric having the higher dielectric constant. In this case, a longer path length of the line of electric force from the radiating element to the ground electrode consequently leads to a state equivalent to the longer distance between the radiating element and the ground electrode. Accordingly, covering the top part of the radiating electrode with the dielectric having the high dielectric constant leads to a lower Q value of the patch antenna and consequently to an increased frequency bandwidth.

Note that in the case where the radiating elements for the different frequency bands are disposed on the shared dielectric substrate, dimensional or manufacturing restriction sometimes prevents the material and the dimensions of the dielectric substrate from being in a suitable state for both of the radiating elements.

In the antenna module 100 in Embodiment 1, the radiating elements 121 and 122 are disposed on the shared dielectric substrate 130, but the dielectrics having the dielectric constants for the respective radiating elements are disposed individually on the dielectric substrate 130. The intensity of the surface acoustic wave of each of the radiating elements 121 and 122 can thereby be controlled individually, and thus the frequency bandwidth of both of the respective radiating elements 121 and 122 disposed even on the shared dielectric substrate 130 can be appropriately increased.

In contrast, an excessively upsized dielectric disposed on the radiating element leads to a larger influence of a surface acoustic wave and thus to a larger spread around the line of electric force, thus possibly causing antenna gain deterioration in an emission direction of the radio wave. That is, increasing the frequency bandwidth by arranging dielectrics with high dielectric constants and ensuring the antenna gain have a tradeoff relationship.

In the antenna module 100 in Embodiment 1, in plan view of the dielectric substrate, at least the distance between the end portion of the radiating element and the end portion of the dielectric in the polarization direction is restricted to be shorter than or equal to ½ of the size of the radiating element. The thickness of the dielectric is also restricted to be ⅕ of the thickness of the radiating element. This prevents an excessive influence of the surface acoustic wave, and thus it is possible to reduce the antenna gain deterioration in the radiating elements 121 and 122 and to appropriately increase the frequency bandwidth.

### (Antenna Characteristics)

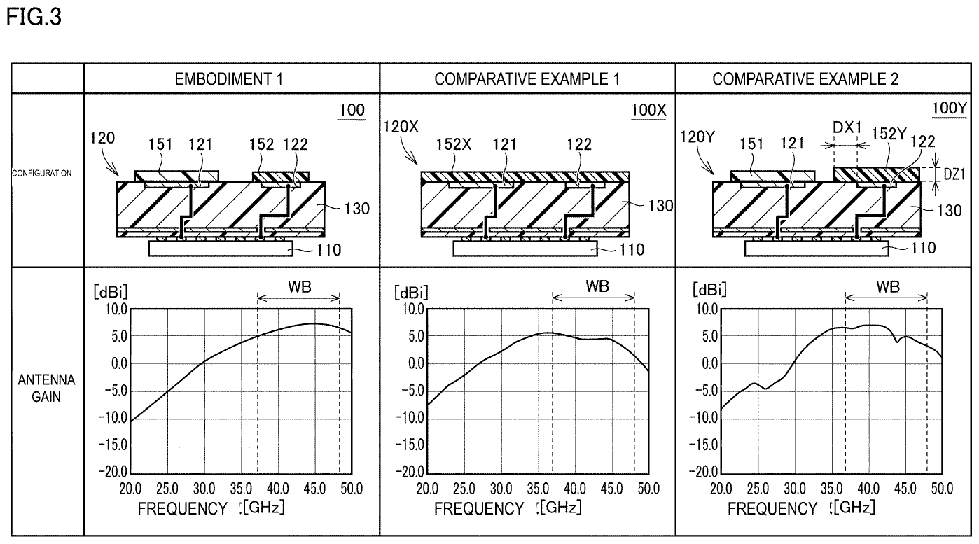

The antenna characteristics of the antenna module 100 in Embodiment 1 will then be described by using FIG. 3 as compared with antenna modules in comparative examples. With FIG. 3, antenna gains regarding radiating elements for higher frequencies in not only the antenna module 100 in Embodiment 1 but also an antenna module 100X in Comparative Example 1 and an antenna module 100Y in Comparative Example 2 will be described.

An antenna device 120X of the antenna module 100X in Comparative Example 1 has a configuration in which a dielectric 152X that covers both of the radiating elements 121 and 122 is disposed on the dielectric substrate 130. The dielectric constant of the dielectric 152X is the same as the dielectric constant of the dielectric 152 applied to the radiating element 122 for higher frequencies in the antenna module 100 in Embodiment 1.

An antenna device 120Y of the antenna module 100Y in Comparative Example 2 has a configuration in which the dielectric 152 corresponding to the radiating element 122 for higher frequencies in the antenna module 100 in Embodiment 1 is made larger in size. In Comparative Example 2, the distances DX1 and DY1 between a dielectric 152Y and the respective end portions of the radiating element 122 in the X-axis direction and the Y-axis direction in plan view in the normal line direction of the dielectric substrate 130 are longer than ½ of the length of the side of the radiating element 122, and the thickness DZ1 of the dielectric 152Y is thicker than ⅕ of the length of the side of the radiating element 122.

Specifically, the dielectric constant of the dielectric substrate is 3, the dielectric constants of the dielectrics 152, 152X, and 152Y are 18, and the length of the side of the radiating element 122 is 0.7 mm. In Embodiment 1, DX1 and DY1 are 0.3 mm, and the thickness DZ1 is 0.1 mm. The thickness DZ1 in Comparative Example 1 is 0.1 mm like Embodiment 1. In Comparative Example 2, DX1 and DY1 are 0.5 mm, and the thickness DZ1 is 0.2 mm.

A frequency band WB covered by the radiating element 122 is from 37 GHz to 48 GHz. As illustrated in FIG. 3, in the antenna module 100 in Embodiment 1, an antenna gain of 5.0 dBi or higher is achieved in the entire frequency band WB. In contrast, in the antenna module 100X in Comparative Example 1, antenna gains in the range from 39 GHz to 47 GHz in the frequency band WB are lower than 5.0 dBi. In the antenna module 100Y in Comparative Example 2, antenna gains in the range from 43.5 GHz to 47 GHz in the frequency band WB are lower than 5.0 dBi. That is, it is understood that if the size of the dielectric is excessively larger than the size of the radiating element, the antenna gains of the radiating element particularly in the higher frequency area of the frequency band are deteriorated.

As described above, the antenna module 100 in Embodiment 1 has the configuration in which individual dielectrics are each disposed to be spaced away from the corresponding radiating element disposed in the shared dielectric substrate, and the dimension of the dielectric is set to be a size appropriate for the size of the corresponding radiating element. The configuration as described above enables the influence of the dielectric on the surface acoustic wave to be increased to an appropriate degree, and it is thus possible to improve the antenna characteristics of the radiating elements even in the configuration in which the radiating elements for the different frequency bands are disposed in the shared dielectric substrate enables.

The radiating element 121 and the radiating element 122 in Embodiment 1 respectively correspond to a first radiating element and a second radiating element in the present disclosure. The dielectric 151 and the dielectric 152 in Embodiment 1 respectively correspond to a first dielectric and a second dielectric in the present disclosure.

### Embodiment 2

For Embodiment 2, a configuration in which a dielectric having a dielectric constant lower than those of the dielectrics on the radiating elements disposed to be spaced away from each other is filled between the dielectrics will be described.

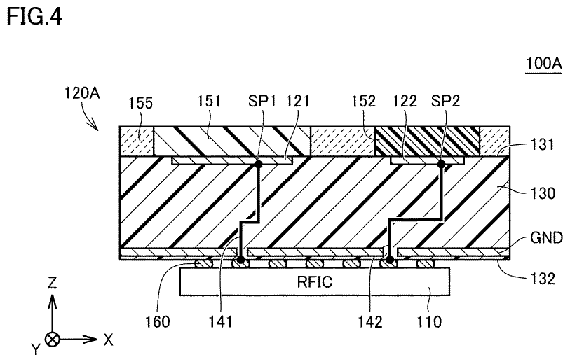

FIG. 4 is a side perspective view of an antenna module 100A according to Embodiment 2. An antenna device 120A of the antenna module 100A has a configuration in which a dielectric 155 is added to the configuration of the antenna module 100 in FIG. 2. In the antenna module 100A in FIG. 4, the configuration except the dielectric 155 is the same as that of the antenna module 100 in FIG. 2. Description overlapping with that of the components in FIG. 2 is not repeated in the description with FIG. 4.

With reference to FIG. 4, the dielectric 155 is disposed in an area where the dielectrics 151 and 152 are not disposed on the upper surface 131 of the dielectric substrate 130. The dielectric constant of the dielectric 155 is lower than the dielectric constants of the dielectrics 151 and 152. The dielectric constant of the dielectric 155 does not have to be higher and also may be lower than the dielectric constant of the dielectric substrate 130.

The thickness of the dielectric 155 (dimension in the Z-axis direction) is preferably the same as the thickness of the dielectrics 151 and 152. Disposing the dielectrics 151, 152, and 155 with the same thickness causes an upper surface of the antenna device 120A to be flat, thus facilitating handling in the manufacturing process or mounting on another substrate. Also in the antenna module 100A in Embodiment 2, the dielectrics of sizes appropriate for the respective radiating elements are individually spaced away from each other, and it is thus possible to improve the antenna characteristics of the radiating elements.

The dielectric 155 in Embodiment 2 corresponds to a fourth dielectric in the present disclosure.

### Embodiment 3

For Embodiments 1 and 2, the antenna module configuration in which the respective radiating elements for the two different frequency bands are disposed in the dielectric substrate has been described.

For Embodiment 3, a configuration of an antenna module formed as an array antenna in which a plurality of radiating elements for respective frequency bands are disposed will be described.

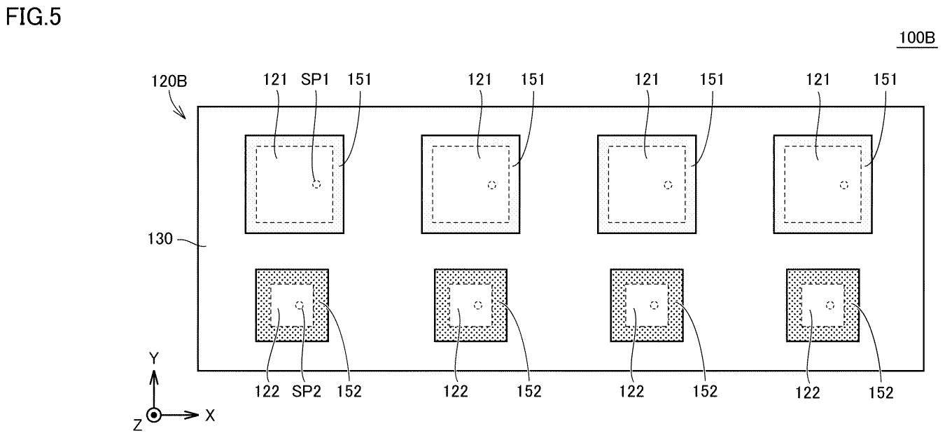

FIG. 5 is a plan view of an antenna module 100B according to Embodiment 3. In an antenna device 120B of the antenna module 100B, the four radiating elements 121 and the four radiating elements 122 are disposed in or on the dielectric substrate 130.

More specifically, in plan view in the normal line direction, the dielectric substrate 130 is shaped into a rectangle having long sides along the X axis. The four radiating elements 121 are disposed in line along the long sides of the dielectric substrate 130 in such a manner as to be spaced away from each other. The four radiating elements 122 are also disposed in line along the long sides of the dielectric substrate 130. The adjacent radiating elements 121 and 122 are disposed to be spaced in the Y-axis direction.

The positions of the radiating elements 122 in or on the dielectric substrate 130 is not limited to the positions in the configuration in which the center positions of each radiating element 121 and the corresponding radiating element 122 adjacent to each other are arranged in the Y-axis direction as illustrated in FIG. 5. For example, each radiating element 122 may be disposed between the two adjacent radiating elements 121.

The radiating elements 121 are disposed to cause the element-to-element pitch of the adjacent radiating elements 121 to be not less than 0.4λ₁ and not more than 0.8λ₁, where λ₁ is the spatial wavelength of a radio wave emitted from each radiating element 121. Likewise, the radiating elements 122 are disposed to cause the element-to-element pitch of the adjacent radiating elements 122 to be not less than 0.4λ₂ and not more than 0.8λ₂, where λ₂ is the spatial wavelength of a radio wave emitted from each radiating element 122. As long as the element-to-element pitch of the radiating elements 122 falls within the range described above, the element-to-element pitch of the radiating elements 122 may be the same as or different from the element-to-element pitch of the radiating elements 121.

The feed point SP1 of each radiating element 121 is disposed at a position shifted from the center of the radiating element 121 in the X-axis direction. The feed point SP2 of each radiating elements 122 is also disposed at a position shifted from the center of the radiating element 122 in the X-axis direction. That is, a radio wave is emitted from each of the radiating elements 121 and 122 in the X-axis direction serving as the polarization direction.

On the upper surface 131 of the dielectric substrate 130, the dielectrics 151 are individually disposed to be spaced away from each other in such a manner as to cover the respective radiating elements 121. As described with reference o FIG. 2, the distance between the end portion of each radiating element 121 and the end portion of the corresponding dielectric 151 in each of the X-axis direction and the Y-axis direction is set to be shorter than or equal to ½ of the length of one of the sides of the radiating element 121.

The dielectrics 152 are individually disposed to be spaced away from each other in such a manner as to cover the respective radiating elements 122. The distance between the end portion of the radiating element 122 and the end portion of the corresponding dielectric 152 in each of the X-axis direction and the Y-axis direction is set to be shorter than or equal to ½ of the length of one of the sides of the radiating element 121.

Also in the array antenna such as the antenna module 100B capable of emitting the radio waves in the two different frequency bands, the dielectrics of sizes appropriate for the respective radiating elements are individually spaced away from each other. It is thus possible to improve the antenna characteristics of the radiating elements and the array antenna as a whole.

The X-axis direction in Embodiment 3 corresponds to a first direction in the present disclosure.

### Modification

For a modification, an array antenna in which the radiating elements are disposed in such a manner as that the polarization direction is inclined with respect to the sides of the dielectric substrate will be described.

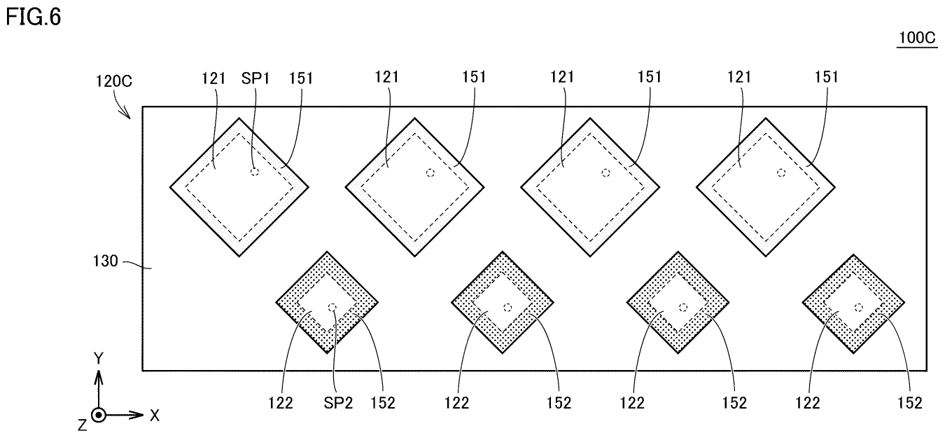

FIG. 6 is a plan view of an antenna module 100C in the modification. Like the antenna module 100B in FIG. 5, an antenna device 120C of the antenna module 100C is an array antenna in which the four radiating elements 121 and the four radiating elements 122 are disposed in or on the dielectric substrate 130. However, in the antenna module 100C, each side of the radiating elements 121 and 122 is disposed to be inclined with respect to each side of the dielectric substrate 130 by 45 degrees.

More specifically, each radiating element 121 is disposed to cause a direction at 45 degrees counterclockwise (CCW) from the X axis to serve as the polarization direction. In contrast, each radiating element 122 is disposed to cause a direction at 45 degrees clockwise (CW) from the X axis to serve as the polarization direction. That is, in the antenna module 100C, the polarization direction of the radio wave emitted from the radiating element 121 is orthogonal to the polarization direction of the radio wave emitted from the radiating element 122.

In the antenna module 100C, the center position of the radiating element 122 is shifted in the X-axis direction with respect to the center position of the radiating element 121 to prevent the radiating element 121 and the radiating element 122 from overlapping.

On the upper surface 131 of the dielectric substrate 130, the dielectrics 151 are individually disposed in such a manner as to cover the respective radiating elements 121, and the dielectrics 152 are individually disposed in such a manner as to cover the respective radiating elements 122.

Also in the configuration of the antenna module 100C in the modification, the dielectrics of sizes appropriate for the respective radiating elements are individually spaced away from each other in the array antenna capable of emitting the radio waves in the two different frequency bands. It is thus possible to improve the antenna characteristics of the radiating elements and the array antenna as a whole.

### Embodiment 4

For Embodiment 4, a configuration of an array antenna in which radiating elements for different three frequency bands are disposed will be described.

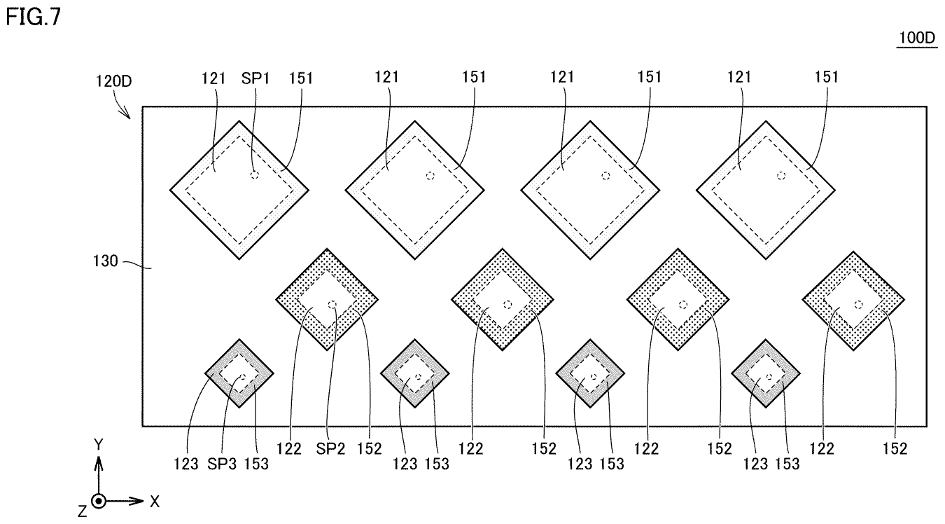

FIG. 7 is a plan view of an antenna module 100D according to Embodiment 4. An antenna device 120D of the antenna module 100D has a configuration in which in addition to the configuration of the antenna module 100C in FIG. 6, four radiating elements 123 capable of emitting a radio wave in a further higher frequency band and dielectrics 153 for these are disposed. Description overlapping with that of the components in FIG. 6 is not repeated in the description with FIG. 7.

With reference to FIG. 7, the dimension of the dielectric substrate 130 in the Y-axis direction in the antenna module 100D is longer than the dimension of the dielectric substrate 130 in the Y-axis direction in the antenna module 100C. The four radiating elements 123 are disposed to be spaced away from each other in line along the sides, in a negative direction of the Y axis, of the dielectric substrate 130.

The size of each radiating element 123 is smaller than the size of each radiating element 122. The frequency band of a radio wave emitted from the radiating element 123 is thus higher than the frequency band of the radio waves emitted from the radiating elements 121 and 122. For example, the frequency band of the radiating element 123 is 60 GHz.

The sides of each radiating element 123 are disposed to be inclined with respect to the sides of the dielectric substrate 130. The center position of the radiating element 123 is shifted in the X-axis direction with respect to the center position of the radiating element 122. In the example in FIG. 7, the position, in the X-axis direction, of the center of the radiating element 123 is the same as the position, in the X-axis direction, of the center of the corresponding radiating element 121.

The dielectrics 153 are individually disposed on the upper surface 131 of the dielectric substrate 130 in such a manner as to cover the respective radiating elements 123. In plan view in the normal line direction of the dielectric substrate 130, the size of each dielectric 153 is larger than the size of the radiating element 123, and a distance between an end portion of the radiating element 123 and an end portion of the corresponding dielectric 153 in each of the polarization direction and the direction orthogonal to the polarization direction is shorter than ½ of the length of each side of the radiating element 123. The thickness of the radiating element 123 is thinner than ⅕ of the length of the side of the radiating element 123.

A dielectric constant ε3 of the dielectric 153 is lower than the dielectric constant ε1 of each dielectric 151 and the dielectric constant ε2 of each dielectric 152 (ε1>ε2>ε3). The radiating element 123 is disposed to cause the element-to-element pitch of the adjacent radiating elements 123 is not less than 0.4λ₃ and not more than 0.8λ₃, where λ₃ is the spatial wavelength of the radio wave emitted from each radiating element 123. The dielectric constant ε3 of the dielectric 153 may be the same as the dielectric constant ε1 of the dielectric 151 and/or the dielectric constant ε2 of the dielectric 152.

Also in the array antenna as described above capable of emitting the radio waves in the different three frequency bands, individually disposing the dielectrics of sizes appropriate for the respective radiating elements to be spaced away from each other enables, to be improved, the antenna characteristics of the radiating elements and the array antenna as a whole.

For the embodiments and the modification above, the case where each radiating element has substantially a square shape in plan view in the normal line direction of the dielectric substrate has been described; however, the shape of the radiating element may be a polygon, a circle, or an ellipse other than the square. In this case, for the size of each dielectric disposed for the corresponding radiating element, a distance between an end portion of the radiating element and an end portion of the dielectric in the polarization direction is set to be shorter than or equal to ½ of the dimension of the radiating element in the polarization direction, and it is thereby possible to achieve antenna gain deterioration reduction and band widening.

For the embodiments and the modification above, the configuration in which the radio wave is emitted in one polarization direction from each radiating element has been described; however, the features of the present disclosure may be applied to a configuration of a so-called a dual polarization type in which radio waves in two different polarization directions are allowed to be emitted from the radiating element. In this case, a distance between an end portion of the radiating element and an end portion of the dielectric in each polarization direction is set to be shorter than or equal to ½ of the dimension of the radiating element in the polarization direction, and it is thereby possible to achieve antenna gain deterioration reduction and band widening.

The embodiments disclosed this time are to be construed as being illustrative and not restrictive in all respects. It is intended that the scope of the present invention is defined by the scope of claims, not by the description of the embodiments above, and include the meaning equivalent to the scope of claims and any change made within the scope.

### REFERENCE SIGNS LIST

10 communication apparatus
100, 100A to 100D, 100X, 100Y antenna module
110 RFIC
111A to 111H, 113A to 113H, 117A, 117B switch
112AR to 112HR low-noise amplifier
112AT to 112HT power amplifier
114A to 114H attenuator
115A to 115H phase shifter
116A, 116B signal multiplexer/demultiplexer
118A, 118B mixer
119A, 119B amplifier circuit
120, 120A to 120D, 120X, 120Y antenna device
121 to 123 radiating element
130 dielectric substrate
131 upper surface
132 lower surface
141, 142 feed wiring line
151 to 153, 152X, 152Y, 155 dielectric
160 solder bumps
200 BBIC
GND ground electrode
SP1, SP2 feed point

1. An antenna module comprising:
a dielectric substrate;
a first radiating element disposed in or on the dielectric substrate;
a second radiating element disposed adjacent to the first radiating element in plan view in a normal line direction of the dielectric substrate;
a first dielectric disposed to cover the first radiating element; and
a second dielectric that is spaced away from the first dielectric and that covers the second radiating element, wherein
the second radiating element is configured to emit a radio wave in a frequency band that that is higher in frequency than another radio wave in another frequency band emitted from the first radiating element, and
the first dielectric and the second dielectric have higher dielectric constants than the dielectric substrate.

2. The antenna module according to claim 1, wherein
the first dielectric has a shape corresponding to the first radiating element, and
the second dielectric has a shape corresponding to the second radiating element.

3. The antenna module according to claim 1,
wherein the dielectric constant of the second dielectric is lower than the dielectric constant of the first dielectric.

4. The antenna module according to claim 1, wherein
in plan view in the normal line direction of the dielectric substrate, the first radiating element and the second radiating element each have substantially a square shape,
a distance between an end portion of the first radiating element and an end portion of the first dielectric in a direction along a side of the first radiating element is shorter than or equal to ½ of a length of the side of the first radiating element, and
a distance between an end portion of the second radiating element and an end portion of the second dielectric in a direction along a side of the second radiating element is shorter than or equal to ½ of a length of the side of the second radiating element.

5. The antenna module according to claim 4, wherein
a dimension of the first dielectric in the normal line direction is shorter than or equal to ⅕ of the length of the side of the first radiating element, and
a dimension of the second dielectric in the normal line direction is shorter than or equal to ⅕ of the length of the side of the second radiating element.

6. The antenna module according to claim 1, wherein
in plan view in the normal line direction of the dielectric substrate, the first radiating element and the second radiating element each have substantially a square shape,
a dimension of the first dielectric in the normal line direction is shorter than or equal to ⅕ of a length of a side of the first radiating element, and
a dimension of the second dielectric in the normal line direction is shorter than or equal to ⅕ of a length of a side of the second radiating element.

7. The antenna module according to claim 1, wherein
a distance between an end portion of the first radiating element and an end portion of the first dielectric in a polarization direction of the another radio wave emitted from the first radiating element is shorter than or equal to ½ of a length as a dimension of the first radiating element in the polarization direction, and
a distance between an end portion of the second radiating element and an end portion of the second dielectric in a polarization direction of the radio wave emitted from the second radiating element is shorter than or equal to ½ of a length as a dimension of the second radiating element in the polarization direction.

8. The antenna module according to claim 7, wherein
a dimension of the first dielectric in the normal line direction is shorter than or equal to ⅕ of the length of the first radiating element in the polarization direction of the another radio wave emitted from the first radiating element, and
a dimension of the second dielectric in the normal line direction is shorter than or equal to ⅕ of the length of the second radiating element in the polarization direction of the radio wave emitted from the second radiating element.

9. The antenna module according to claim 1, wherein
the another frequency band of the another radio wave emitted from the first radiating element is a 28 GHz band, and
the frequency band of the radio wave emitted from the second radiating element is a 39 GHz band.

10. The antenna module according to claim 1, further comprising:
a third radiating element disposed adjacent to the first radiating element and the second radiating element in plan view in the normal line direction of the dielectric substrate; and
a third dielectric disposed to be spaced away from the first dielectric and the second dielectric and to cover the third radiating element, wherein
a frequency band of a radio wave emitted from the third radiating element is higher than the frequency band of the radio wave emitted from the second radiating element, and
the third dielectric has a higher dielectric constant than the dielectric substrate.

11. The antenna module according to claim 10,
wherein the frequency band of the radio wave emitted from the third radiating element is a 60 GHz band.

12. An antenna module comprising:
a dielectric substrate;
a plurality of first radiating elements arranged in a first direction in or on the dielectric substrate;
a plurality of second radiating elements arranged in the first direction adjacent to the plurality of first radiating elements in plan view in a normal line direction of the dielectric substrate;
first dielectrics each disposed to individually cover a corresponding one of the plurality of first radiating elements; and
second dielectrics each disposed to be spaced away from a corresponding one of the first dielectrics and to individually cover a corresponding one of the plurality of second radiating elements,
wherein the plurality of second radiating elements are configured to emit radio waves in a frequency band that is higher in frequency than other radio waves emitted in another frequency band from each of the plurality of first radiating elements, and
wherein the first dielectrics and the second dielectrics have higher dielectric constants than the dielectric substrate.

13. The antenna module according to claim 12, wherein
a pitch between centers of the plurality of first radiating elements in the first direction is not less than 0.4λ₁ and not more than 0.8λ₁, where λ₁ is a spatial wavelength of the other radio waves emitted from each of the plurality of first radiating elements, and
a pitch between centers of the plurality of second radiating elements in the first direction is not less than 0.4λ₂ and not more than 0.8λ₂, where λ₂ is a spatial wavelength of the radio wave emitted from each of the plurality of second radiating elements.

14. The antenna module according to claim 1, further comprising:
a fourth dielectric disposed between the dielectrics in plan view in the normal line direction of the dielectric substrate, the fourth dielectric having a dielectric constant lower than the dielectric constants of the dielectrics.

15. The antenna module according to claim 1, further comprising:
a feeder circuit configured to supply a radio frequency signal to each of the radiating elements.

16. A communication apparatus comprising:
a baseband integrated circuit that performs baseband processing on signals exchanged with an antenna module; and
the antenna module, the antenna module including
a dielectric substrate,
a first radiating element disposed in or on the dielectric substrate,
a second radiating element disposed adjacent to the first radiating element in plan view in a normal line direction of the dielectric substrate,
a first dielectric disposed to cover the first radiating element, and
a second dielectric that is spaced away from the first dielectric and that covers the second radiating element, wherein
the second radiating element is configured to emit a radio wave in a frequency band that that is higher in frequency than another radio wave in another frequency band emitted from the first radiating element, and
the first dielectric and the second dielectric have higher dielectric constants than the dielectric substrate.

17. The communication device of claim 16, wherein
the first dielectric has a shape corresponding to the first radiating element, and
the second dielectric has a shape corresponding to the second radiating element.

18. The communication device of claim 16, wherein the dielectric constant of the second dielectric is lower than the dielectric constant of the first dielectric.

19. The communication device of claim 16, wherein
in plan view in the normal line direction of the dielectric substrate, the first radiating element and the second radiating element each have substantially a square shape,
a distance between an end portion of the first radiating element and an end portion of the first dielectric in a direction along a side of the first radiating element is shorter than or equal to ½ of a length of the side of the first radiating element, and
a distance between an end portion of the second radiating element and an end portion of the second dielectric in a direction along a side of the second radiating element is shorter than or equal to ½ of a length of the side of the second radiating element.

20. The communication device of claim 19, wherein
a dimension of the first dielectric in the normal line direction is shorter than or equal to ⅕ of the length of the side of the first radiating element, and
a dimension of the second dielectric in the normal line direction is shorter than or equal to ⅕ of the length of the side of the second radiating element.
